(19) United States
(12) Patent Application Publication
(10) Pub. No.: US 2016/0213200 A1
(43) Pub. Date: Jul. 28, 2016

(54) COMBINATION KNIFE AND CUTTING BOARD

(71) Applicant: Paul Brown, Torrington, CT (US)

(72) Inventor: Paul Brown, Torrington, CT (US)

(21) Appl. No.: 14/605,510

(22) Filed: Jan. 26, 2015

(51) Int. Cl. A47J 47/00; B25H 1/04; B23Q 3/00

(52) U.S. Cl. CPC A47J 47/005; B23Q 3/00; B25H 1/04

(57) ABSTRACT

A cutting board system is provided and includes a board base, a board back stop, a board front stop and a knife anchor, wherein the knife anchor includes at least one knife interface sleeve which includes a sleeve cavity for receiving and containing the knife, wherein the knife is configurable between a first configuration and a second configuration via the at least one knife interface sleeve.

### RELATED APPLICATIONS

This application is related to and claims benefit of priority of U.S. Provisional Patent Application Ser. No. 61/932,610 (Attorney Docket No. BRO-0001-P), filed Jan. 28, 2014, the contents of which are incorporated by reference herein in its entirety.

### FIELD OF THE INVENTION

This invention relates generally to an article for cutting food and more particularly to a knife and cutting board combination.

### BACKGROUND OF THE INVENTION

Cutting food products, such as fruit, bread, vegetable, etc, can be a laborious and dangerous task not only for people with motor skill problems, but for people without motor skill problems as well. All too often either the person cutting the food product is forced to hold the product proximate the area that is being cut or the product is slippery and/or awkward to hold in a stabilized position. Thus, in many cases the food product moves (or slips) causing the cutting knife to slip resulting in an injury to the person cutting the product.

One way to address this problem is to provide a stable platform with which a food product can be securely held in place and cut without the hand of the user being located in an area where the knife can cut the hand of the user if it slips. However, current devices are hard to use and thus still unsafe. Additionally, the current devices need specialized knife designs and cannot be used with ordinary knives.

### SUMMARY OF THE INVENTION

A cutting board system is provided in accordance with the present invention and includes a board base, a board back stop, a board front stop and a knife anchor, wherein the knife anchor includes at least one knife interface sleeve which includes a sleeve cavity for receiving and containing the knife, wherein the knife is configurable between a first configuration and a second configuration via the at least one knife interface sleeve.

A cutting board system is provided and includes a board base, a board back stop a board front stop and a knife anchor, wherein the knife anchor includes a knife interface sleeve which includes a sleeve cavity for receiving and containing a knife blade tip, wherein the knife interface sleeve is configurable between a first configuration and a second configuration

A cutting board system is provided and includes a board base, a board back stop, a board front stop and a knife anchor, wherein the knife anchor includes at least one knife interface sleeve which includes a sleeve cavity for receiving and containing a knife blade tip, wherein the knife interface sleeve is rotatable in a vertical plane.

### BRIEF DESCRIPTION OF THE DRAWINGS

The foregoing and other features and advantages of the present invention will be more fully understood from the following detailed description of illustrative embodiments, taken in conjunction with the accompanying drawings in which like elements are numbered alike:

FIG. 1A is a top down view of the cutting board system, in accordance with one embodiment of the invention.

FIG. 1B is a top down view of the cutting board system of FIG. 1 without a knife.

FIG. 2 is a front view of the cutting board system of FIG. 1.

FIG. 3 is a side view of the cutting board system of FIG. 1.

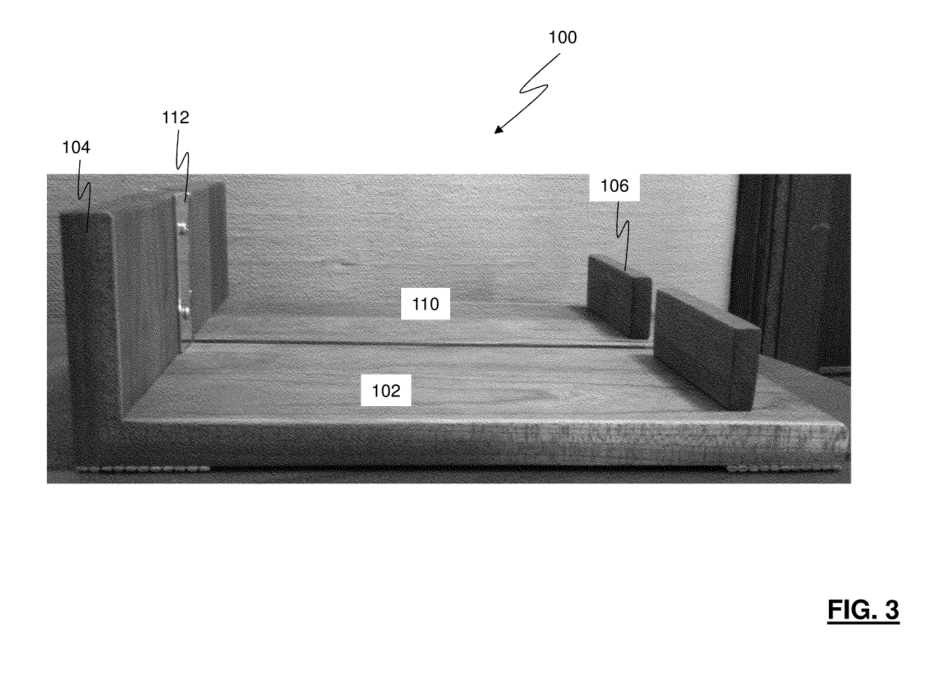

FIG. 4 is a back view of the cutting board system of FIG. 1.

FIG. 5 is a back view of a knife anchor for use with the cutting system of FIG. 1, in accordance with one embodiment.

FIG. 6 is a side view of the knife anchor of FIG. 5.

FIG. 7 is a front view of the knife anchor of FIG. 5 showing the sleeve cavities.

FIG. 8A is a side view of the knife anchor of FIG. 5.

FIG. 8B is a side view of the knife anchor of FIG. 5 showing the knife and knife interface sleeve rotate in vertical axis.

FIG. 9 is a side view of a knife anchor for use with the cutting system of FIG. 1, in accordance with another embodiment.

FIG. 10 is a back view of the knife anchor of FIG. 9.

FIG. 11 is a front view of the knife anchor of FIG. 9, showing the sleeve cavity.

FIG. 12 is a side view of the tip of a knife having a magnetic insert for use with the cutting system, in accordance with another embodiment.

FIG. 13 is a top down view of a cutting board where the knife anchor is rotatable to allow the knife to rotate, in accordance with another embodiment.

### DETAILED DESCRIPTION OF THE INVENTION

As disclosed herein with regards to an exemplary embodiment, a novel cutting board system is disclose and described herein. It should be appreciated that the cutting board system is configured to accommodate and thus, operate, with most sharp kitchen knives and adjustable to securely stabilize food products of various sizes. Additionally, it is contemplated that, in at least one embodiment, the cutting board system can be broken down into several parts for easy storage and cleaning.

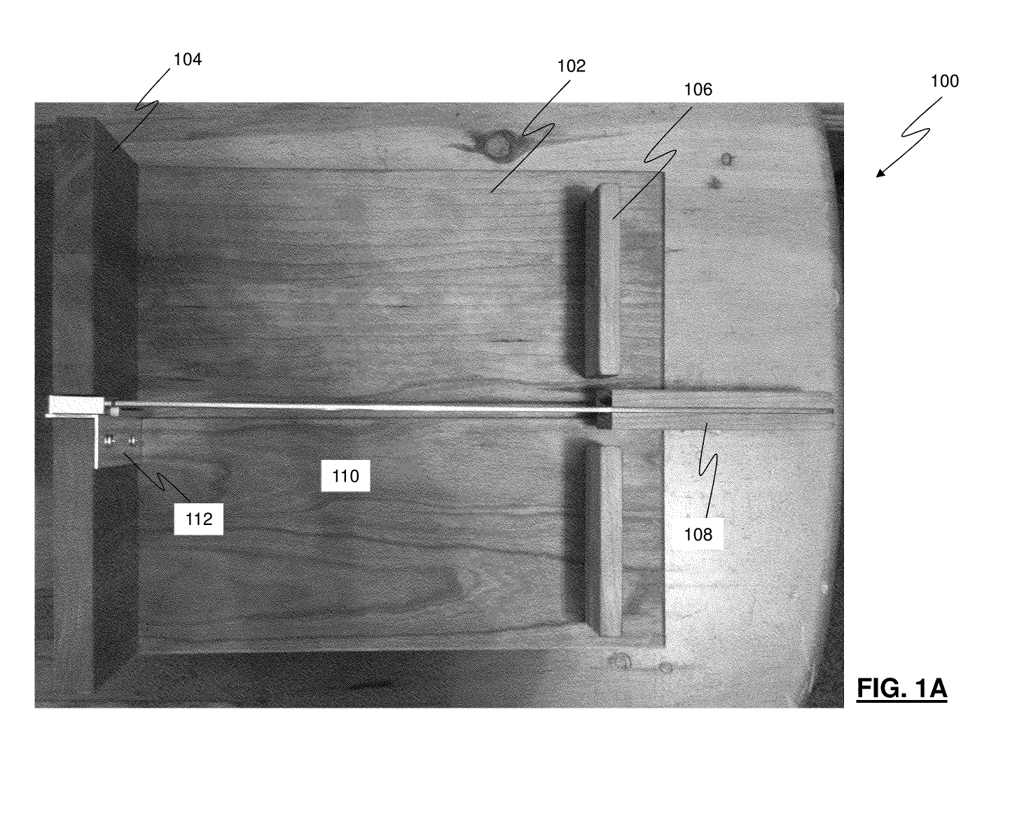

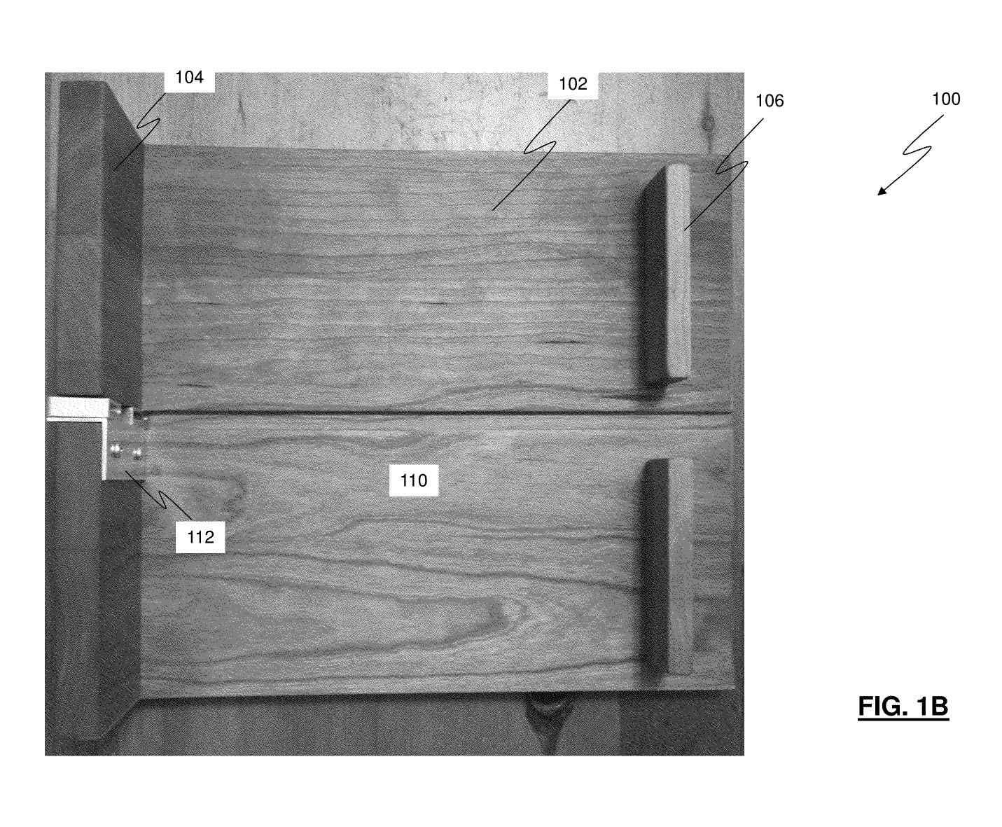

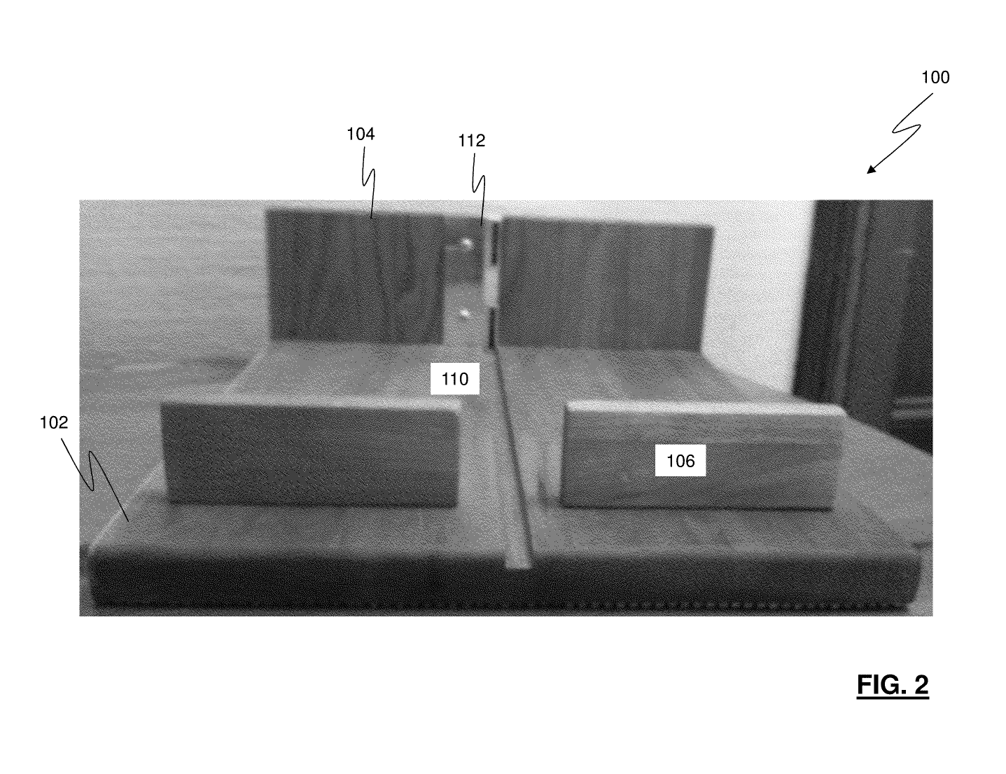

Referring to FIG. 1 and FIG. 2, a cutting board system 100 in accordance with one embodiment of the invention is illustrated and includes a board base 102, a board back stop 104, a board front stop 106 and a knife 108, wherein the knife is removably associated with the board back stop 104. It should be appreciated that the board base 102, board back stop 104 and the board front stop 106 defines a board cutting area 110 where the item being cut will typically be located during the cutting. Additionally, the board front stop 106 may be constructed of multiple pieces (as shown) or the board front stop 106 may be constructed of one piece.

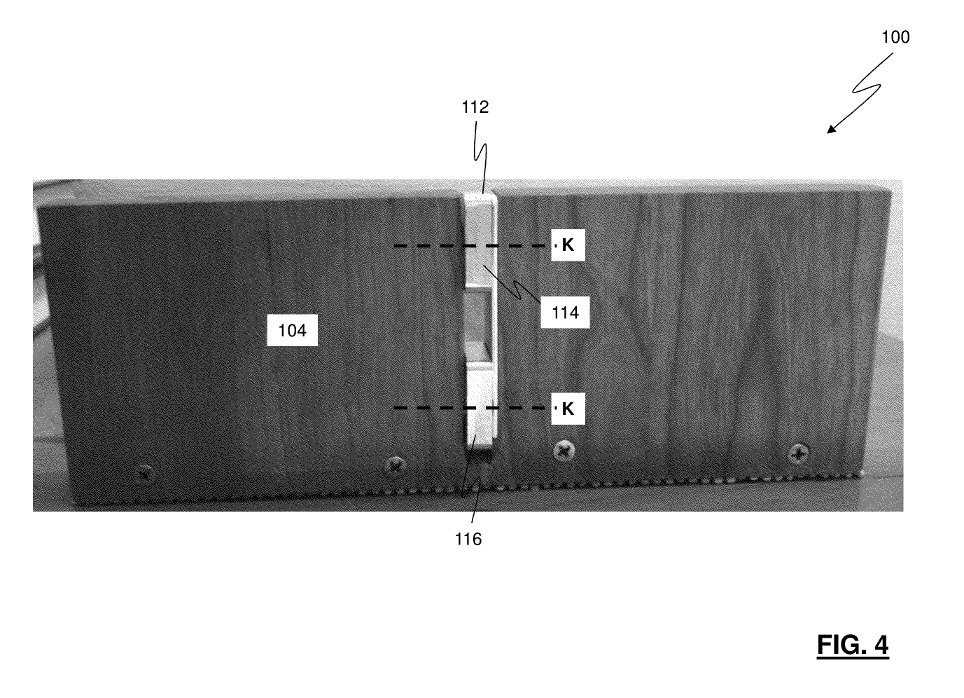

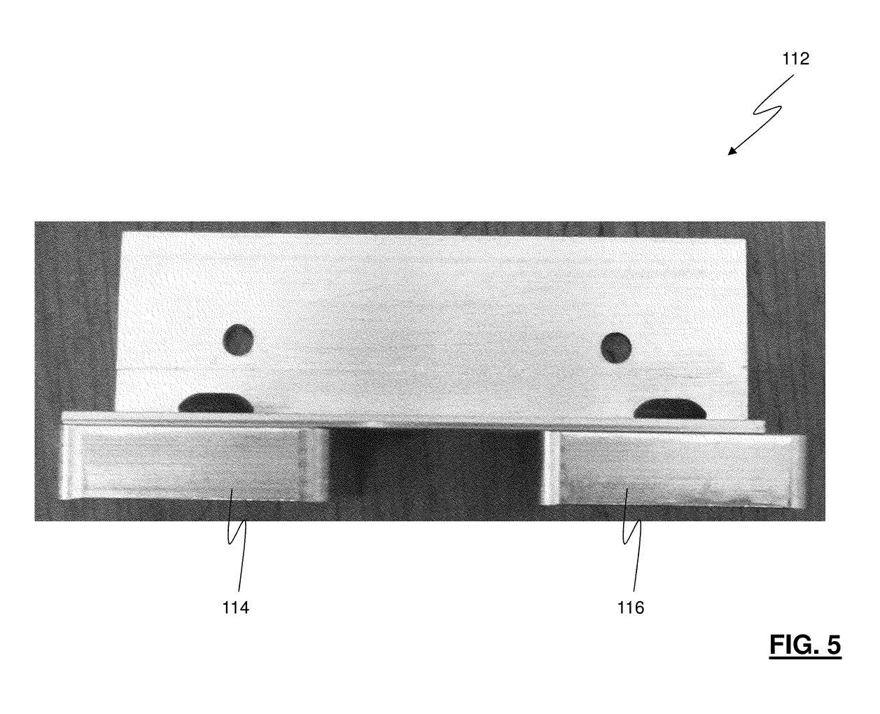

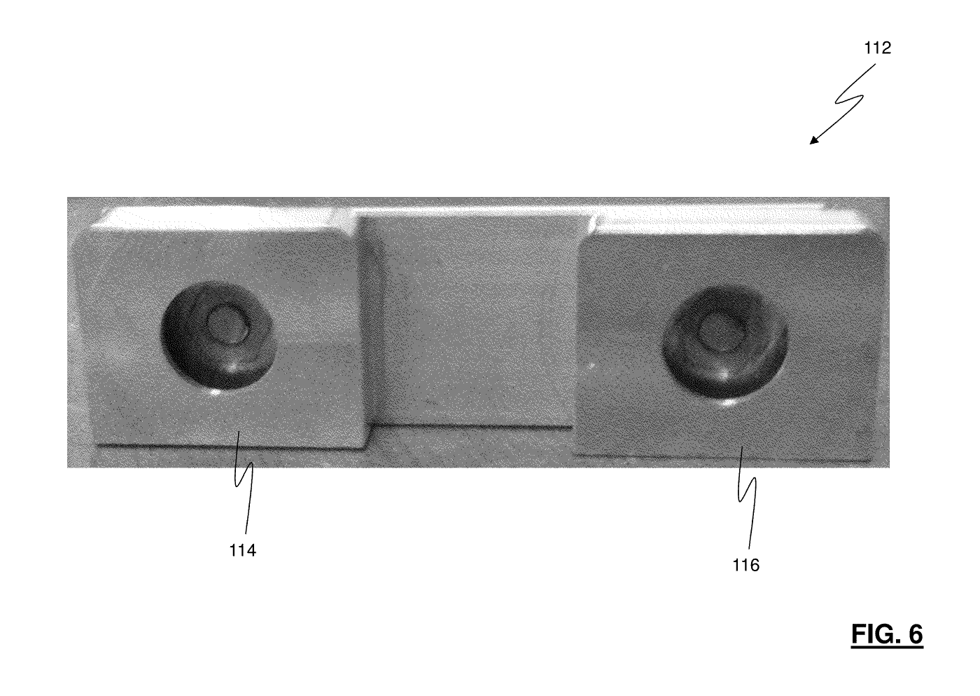

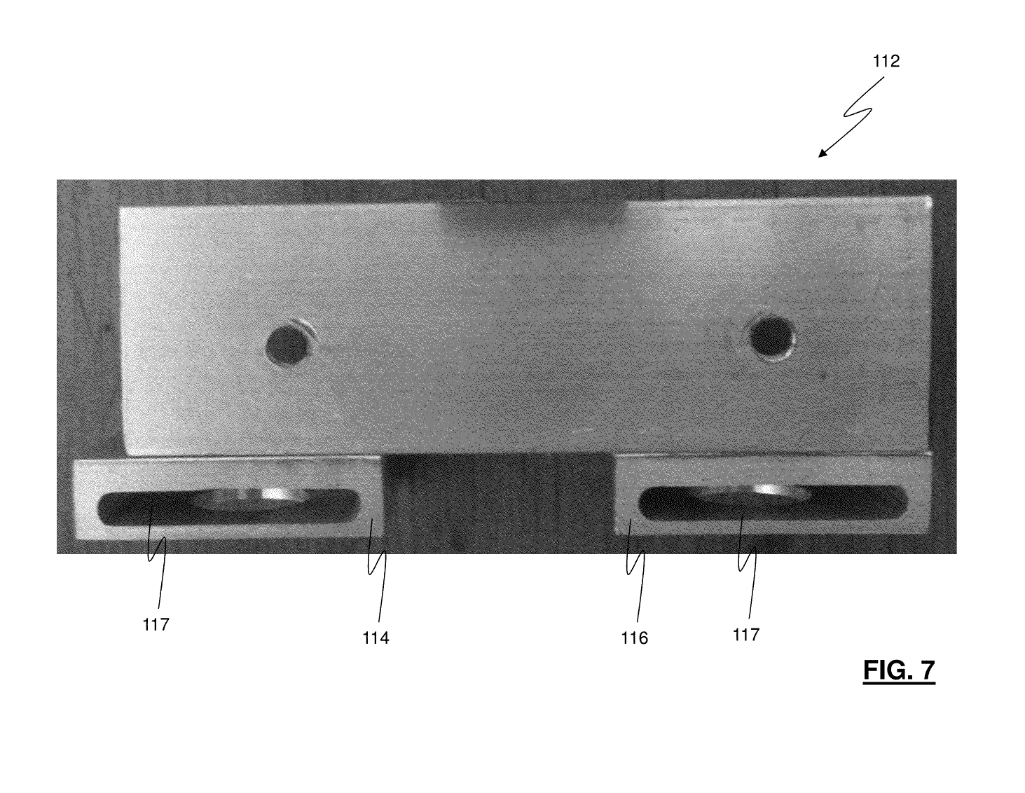

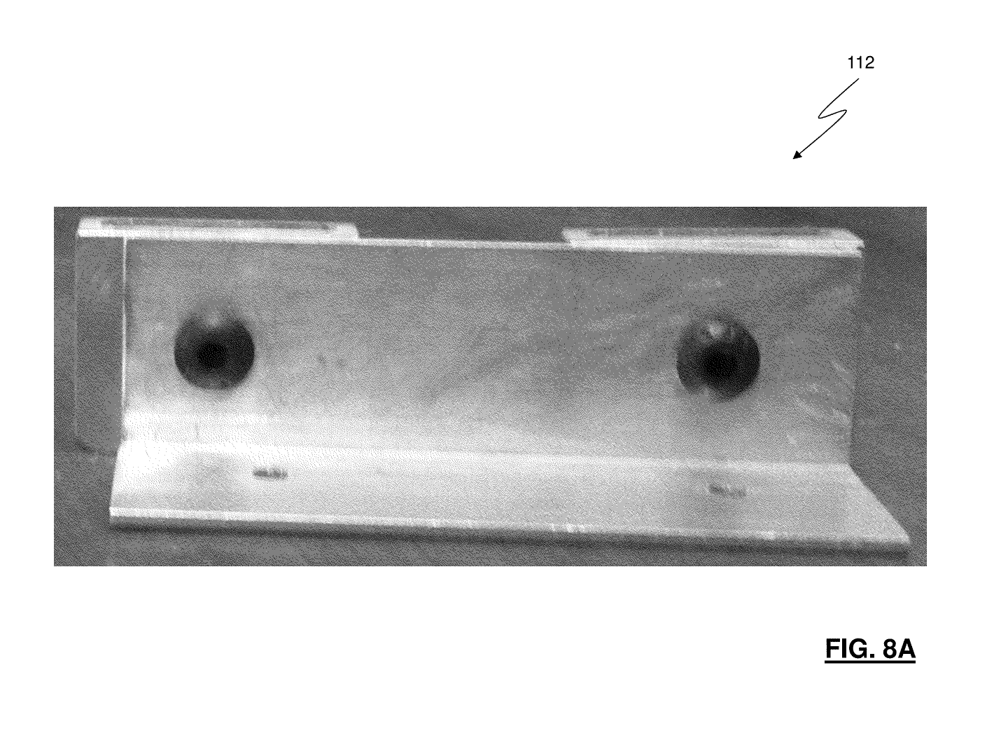

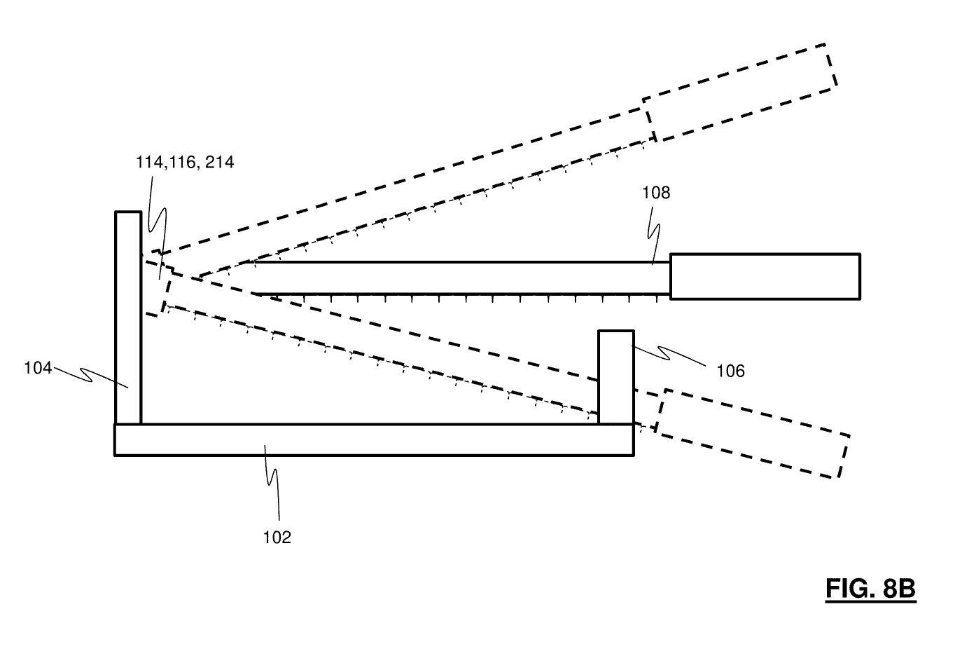

The board back stop 104 includes a knife anchor 112 located proximate the center of the board back stop 104. Referring to FIG. 4, FIG. 5, FIG. 6, FIG. 7, FIG. 8A and FIG. 8B, the knife anchor 112 is non-movably associated with the board back stop 104 and includes a first knife interface sleeve 114 and a second knife interface sleeve 116, each of which rotates about axis K and includes a sleeve cavity 117 to receive and contain the tip of the knife 108. It should be appreciated that the first knife interface sleeve 114 is located proximate the top of the board back stop 104 and the second knife interface sleeve 116 is located proximate the bottom of the board back stop 104. This advantageously allows the knife to be configurable to cut large and small items. For example, when cutting larger items, the knife is located in the first knife interface sleeve 114 and when cutting smaller items, the knife 108 is located in the first knife interface sleeve 116. Also, the rotatability of the first knife interface sleeve 114 and second knife interface sleeve 116 advantageously allows the knife 108 to be raised and lowered in a cutting fashion.

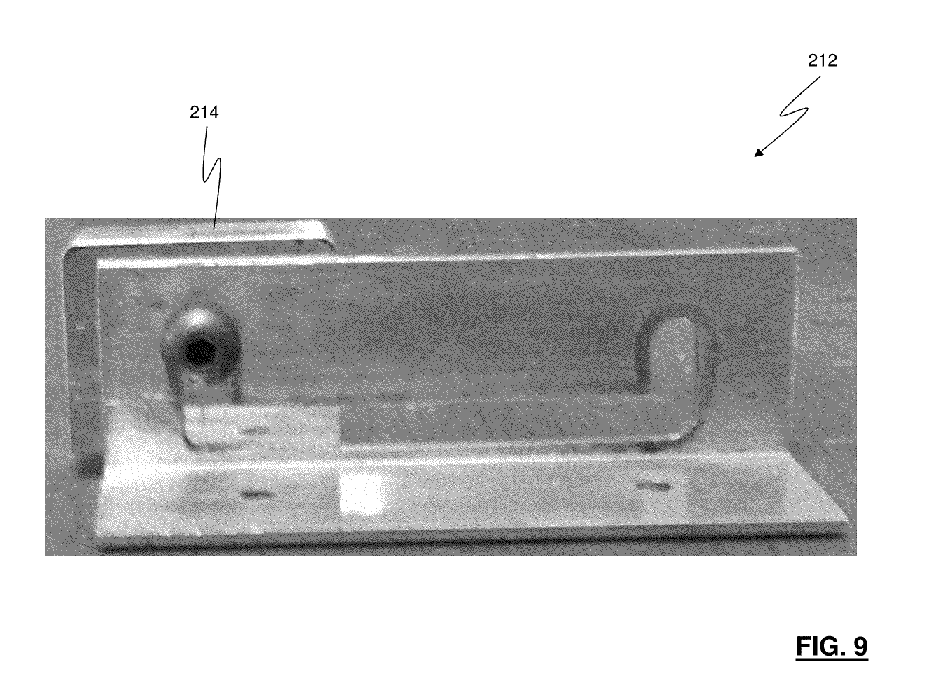

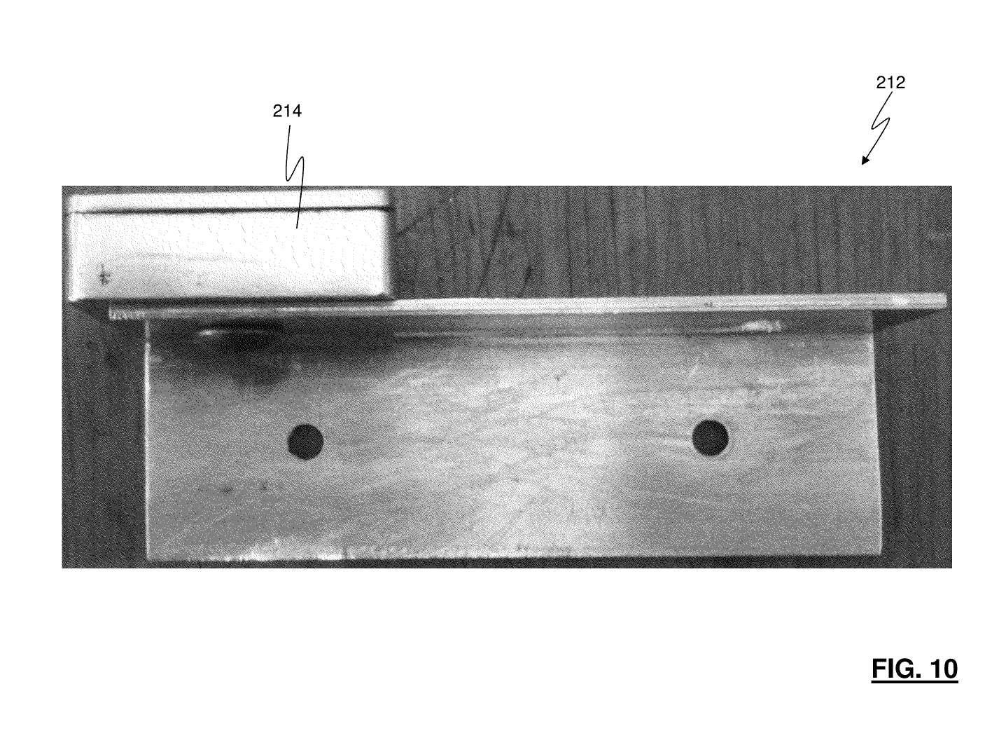

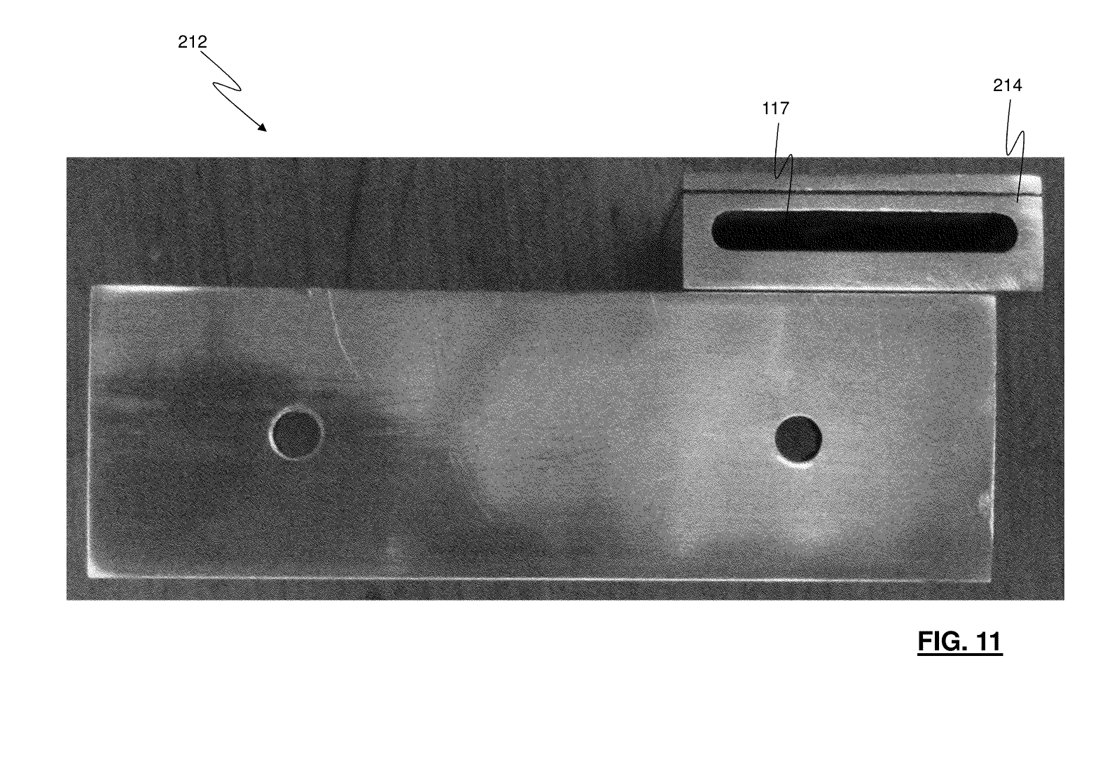

Referring to FIG. 9, FIG. 10 and FIG. 11, an additional embodiment of the cutting board system 100 would include a knife anchor 212 having only one knife interface sleeve 214, where the knife interface sleeve 214 is positionable between a first configuration and a second configuration. When the knife anchor 212 is securely associated with the board back stop 104 and configured to be in the first configuration, the knife interface sleeve 214 is located proximate the top of the board back stop 104. When configured in the second configuration, the knife interface sleeve 214 is located proximate the bottom of the board back stop 104.

It should be appreciated that in one embodiment, the knife interface sleeve 114, 116, 214 (and/or the knife tip) may be magnetized to assist in retaining the tip of the knife 108 with the sleeve 114, 116, 214. Moreover, in additional embodiments, the knife 108 may include a guide projection and the cavity 117 of the sleeve 114, 116, 214 may include a guide projection channel. As the knife 108 is inserted into the cavity 117 of the sleeve 114, 116, 214, the guide production would interact with the guide projection channel to help retain the tip of the knife 108 with the cavity 117 of the sleeve 114, 116, 214. In still yet another embodiment, the board front stop 106 (all or only a portion of the board front stop 106) may be configurable to be positioned at various locations on the board base 102. This would advantageously allow the board cutting area to be adjustable to accommodate large and small items, as desired.

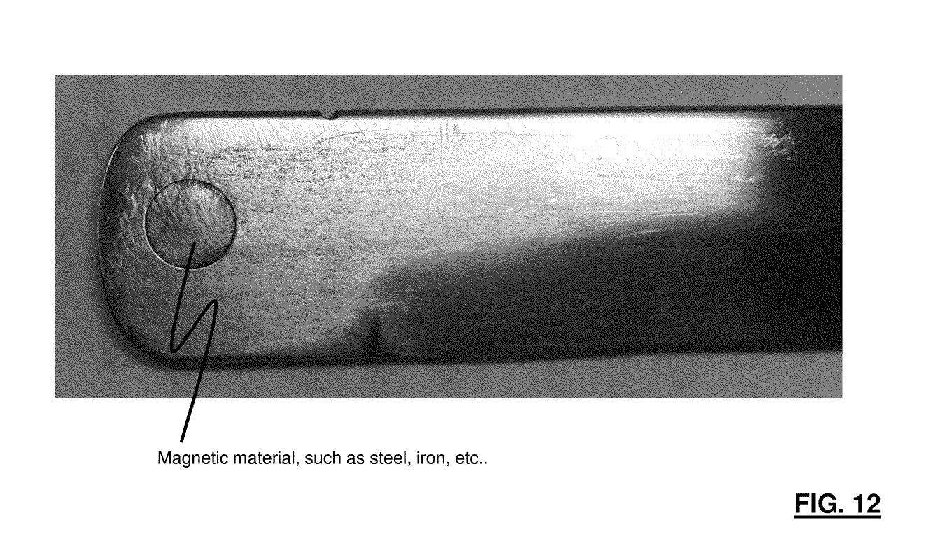

Referring to FIG. 12, it is contemplated that the tip or a portion of the tip of the knife (and/or a portion of the cutting sleeve) may be constructed of a ferromagnetic material, such as steel, iron, etc. to assist in moving the sleeve into various positions. As the knife is inserted into the sleeve, the magnetic interaction between the sleeve and the knife allows the sleeve to be repositioned using the knife.

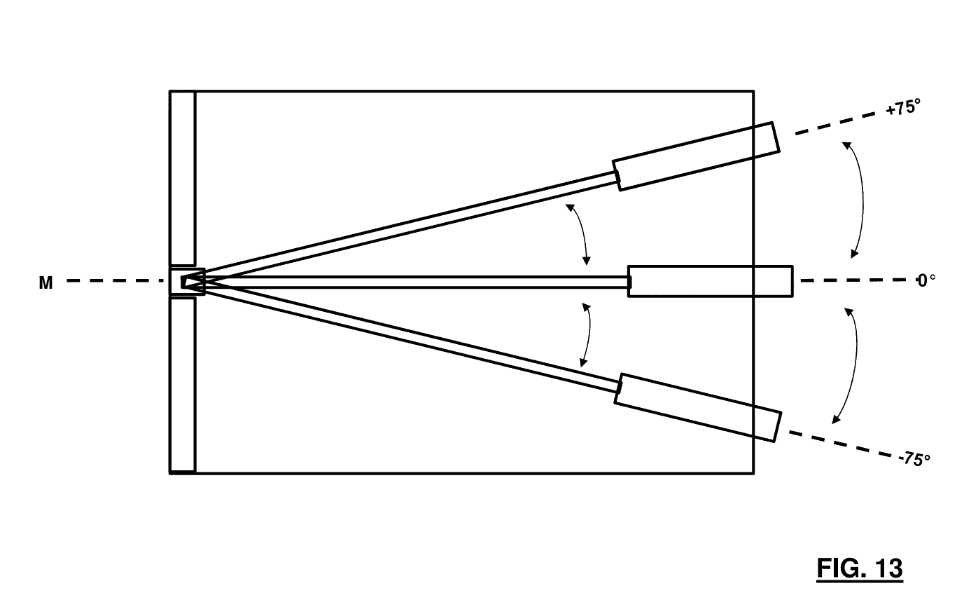

In still yet another embodiment, referring to FIG. 13 it is contemplated that the knife anchor 112, 212 may be configured to rotate about an axis M to allow the knife to be angled relative to the board back stop 104. It should be appreciated that cutting board system (together or it elements separately) may be constructed from any materials or combination of materials suitable to the desired end purpose. For example, in one embodiment, the board base 102, board back stop 104 and board front stop 106 may be constructed from wood, while the knife anchor 112, 212 may be constructed from a metallic material. In another embodiment, the board base 102, board back stop 104, board front stop 106 and knife anchor 112, 212 may be constructed from a plastic material.

While the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of any appended claims. Moreover, unless specifically stated any use of the terms first, second, etc. do not denote any order or importance, but rather the terms first, second, etc. are used to distinguish one element from another.

I claim:

1. A cutting board system, comprising:
a board base;
a board back stop;
a board front stop; and
a knife anchor, wherein the knife anchor includes a knife interface sleeve which includes a sleeve cavity for receiving and containing a knife blade tip, wherein the knife interface sleeve is configurable between a first configuration and a second configuration.

2. The cutting board system of claim 1, wherein the knife interface sleeve is rotatable in the vertical plane about an axis K between about 0° and about 90°.

3. The cutting board system of claim 1, wherein the knife interface sleeve is configurable between a first configuration and a second configuration.

4. The cutting board system of claim 3, wherein the board back stop includes a board back stop top and a board back stop bottom.

5. The cutting board system of claim 4, wherein when the knife interface sleeve is in the first configuration, the knife interface sleeve is located proximate the board back stop top and when the knife interface sleeve is in the second configuration, the knife interface sleeve is located proximate the board back stop bottom.

6. The cutting board system of claim 5, wherein the knife interface sleeve includes a magnetic portion such that when the knife blade tip is located within the knife interface sleeve the magnetic portion interacts with the knife blade tip.

7. The cutting board system of claim 1, wherein the knife interface sleeve is rotatable in the horizontal plane about an axis M between about +75° and about −75°.

8. A cutting board system, comprising:
a board base;
a board back stop;
a board front stop; and
a knife anchor, wherein the knife anchor includes at least one knife interface sleeve which includes a sleeve cavity for receiving and containing a knife blade tip, wherein the knife interface sleeve is rotatable in a vertical plane.

9. The cutting board system of claim 8, wherein the at least one knife interface sleeve is rotatable in the vertical plane about an axis K between about 0° and about 90°.

10. The cutting board system of claim 8, wherein the at least one knife interface sleeve is configurable between a first configuration and a second configuration.

11. The cutting board system of claim 10, wherein the board back stop includes a board back stop top and a board back stop bottom.

12. The cutting board system of claim 11, wherein when the at least one knife interface sleeve is in the first configuration, the at least one knife interface sleeve is located proximate the board back stop top and when the at least one knife interface sleeve is in the second configuration, the at least one knife interface sleeve is located proximate the board back stop bottom.

13. The cutting board system of claim 5, wherein the at least one knife interface sleeve includes a magnetic portion such that when the knife blade tip is located within the knife interface sleeve the magnetic portion interacts with the knife blade tip.

14. The cutting board system of claim 8, wherein the knife interface sleeve is rotatable in a horizontal plane about an axis M between about +75° and about −75°.
